(19) United States
(12) Patent Application Publication
(10) Pub. No.: US 2016/0056972 A1
(43) Pub. Date: Feb. 25, 2016

(54) WEB OF THINS PLUG-IN SYSTEM

(71) Applicant: Electronics and Telecommunications Research Institute, Daejeon (KR)

(72) Inventors: Se-Won OH, Daejeon (KR); Hyun-Joong KANG, Jinju-si Gyeongsangnam-do (KR); Young-Bag MOON, Seoul (KR); Sang-Gi HONG, Daejeon (KR); Mal-Hee KIM, Daejeon (KR); Ho-Sung LEE, Daejeon (KR)

(21) Appl. No.: 14/831,569

(22) Filed: Aug. 20, 2015

(30) Foreign Application Priority Data
Aug. 22, 2014 (KR) 10-2014-0109636

(51) Int. Cl. H04L 12/28; H04L 12/911

(52) U.S. Cl. CPC H04L 12/2818; H04L 12/2825; H04L 47/70

(57) ABSTRACT

Exemplary embodiments of the present invention relate to a resource processing scheme which can be used for web of things services. The web of things plug-in system according to exemplary embodiments of the present invention comprises: a web of things resource storing unit configured to store a web of things resource which represent at least one of a thing itself and any data produced by the thing; and a web of things resource processing unit configured to perform resource processing on the web of things resources stored in the web of things resource storing unit. According to exemplary embodiments of the present invention, information from things can be provided in the form of web resources through the web to web of things service user as well as to another things.

### CROSS REFERENCE TO RELATED APPLICATION

This application claims the benefit of Korean Patent Application No. 10-2014-0109636, filed on Aug. 22, 2014, entitled “Web of things plug-in system”, which is hereby incorporated by reference in its entirety into this application.

### BACKGROUND

1. Technical Field

Exemplary embodiments of the present invention relate to a resource processing scheme being used in web of things services.

2. Description of the Related Art

Internet of things (IoT) technique provides various information (e.g., location, operation conditions, temperature, humidity and discomfort index, acceleration and traveled distance, etc. of things) or allows services (e.g., brightness control and indoor temperature control, etc.) to remotely control things through information exchanges between things in which communication functions are embedded.

Particularly, services, which access information about things or control specific operations such as measuring current temperature, turning switch on/off and the like by utilizing the conventional world wide web (hereinafter, referred to Web) techniques, are called as web-based IoT services or web of things (WoT) services.

It is demanded to represent information about things with web resources and process them stably in order to provide reliable web of things services.

### SUMMARY

Exemplary embodiments of the present invention provide a method for accessing web of things resources stably through the web by a web of things service user or a thing.

Exemplary embodiments of the present invention provide a method for processing web of things resources or controlling things' operation.

A web of things plug-in system according to an embodiment of the present invention comprises a web of things resource storing unit configured to store web of things resources which represent at least one of a thing itself and any data produced by the thing; and a web of things resource processing unit configured to perform resource processing on the web of things resources stored in the web of things resource storing unit.

In an embodiment of the present invention, the web of things plug-in system may further comprise a communication protocol processing unit configured to transmit a web of things resource processing request to the web of things resource processing unit and to output web of things resource processing result received from the web of things resource processing unit corresponding to the web of things resource processing request.

In an embodiment of the present invention, the communication protocol processing unit may comprise a web-based communication protocol processing unit configured to receive the web of things resource processing request from a user terminal and to output the web of things resource processing result to the user terminal; and a local communication protocol processing unit configured to receive the web of things resource processing request from a thing, and to output the web of things resource processing result to the thing.

In an embodiment of the present invention, the web of things plug-in system may further comprise a message channel configured to be located between the communication protocol processing unit and the web of things resource processing unit and to transmit at least one of the web of things resource processing request and the web of things resource processing result.

In an embodiment of the present invention, the web of things plug-in system may further comprise an activation management unit configured to control activation states of component units included in the web of things plug-in system based on the activation state of the web of things resource processing unit.

In an embodiment of the present invention, the activation management unit may activate the communication protocol processing unit when the web of things resource processing unit converts from an inactive state to an active state.

In an embodiment of the present invention, the activation management unit may deactivate the communication protocol processing unit when the web of things resource processing unit converts from an active state to an inactive state.

In an embodiment of the present invention, the web of things plug-in system may further comprise a web of things application agent configured to generate a new web of things resource based on the web of things resource stored in the web of things resource storing unit, update the web of things resource stored in the web of things resource storing unit, or generate information of its own web of things plug-in system as web of things resources and store the result in the web of things resource storing unit.

In an embodiment of the present invention, the resource processing may be related to any one of creating, storing, searching, reading, updating and deleting.

In an embodiment of the present invention, the web of things resource processing unit may transmit an instruction to control the thing to the thing when any resource processing of creating, reading, and updating is made.

In an embodiment of the present invention, the web of things resource processing unit may, when a predetermined circumstance occurs, transmit a notification relating to the circumstance to the user or to the thing which is related to the circumstance.

In an embodiment of the present invention, the web of things resources may be web resources to which at least one of information about things and operation functions of the things is converted.

According to exemplary embodiments of the present invention, web of things services can be provided to a user by converting information about things or operation functions of the things as web resources.

According to exemplary embodiments of the present invention, web of things resources can be processed in the order to ensure the integrity of web of things resources even if requests to access to web of things resources are frequently occurred or requests to access to web of things resources are made by many web of things service users at the same time.

### BRIEF DESCRIPTION OF DRAWING

FIG. 1 is an exemplary view illustrating web of things service environment configuration in which embodiments of the present invention are applied.

FIG. 2 is a block view illustrating a web of things plug-in system according to an embodiment of the present invention.

FIG. 3 is a block view illustrating a web of things plug-in system according to another embodiment of the present invention.

FIG. 4 is a block view illustrating a web of things plug-in system according to still another embodiment of the present invention.

FIG. 5, FIG. 6, FIG. 7 and FIG. 8 are exemplary views illustrating processes for accessing specific web of things resource accommodated by a web of things plug-in system, according to embodiments of the present invention.

FIG. 9 is an exemplary view illustrating a process for controlling things' movement with a web of things plug-in system according to an embodiment of the present invention.

FIG. 10 is an exemplary view illustrating a notification process when a specific circumstance occurs in a web of things plug-in system according to an embodiment of the present invention.

FIG. 11 is a block view illustrating a web of things plug-in system according to still another embodiment of the present invention.

FIG. 12 is a block view illustrating a web of things plug-in system according to still another embodiment of the present invention.

FIG. 13, FIG. 14 and FIG. 15 are exemplary views illustrating messages which are transmitted through a message channel according to an embodiment of the present invention. FIG. 16 is a block view illustrating a web of things plug-in system according to still another embodiment of the present invention.

FIG. 17 is an exemplary view illustrating changes in activation states of component units included in a web of things plug-in system according to an embodiment of the present invention.

FIG. 18 is an exemplary view illustrating a process for controlling activation states of component units included in a web of things plug-in system according to an embodiment of the present invention by an activation management unit.

### DESCRIPTION OF THE EXEMPLARY EMBODIMENTS

Throughout the description of the present invention, when describing a certain technology is determined to evade the point of the present invention, the pertinent detailed description will be omitted.

Hereinafter, exemplary embodiments of the present invention will be described with reference to the accompanying drawings.

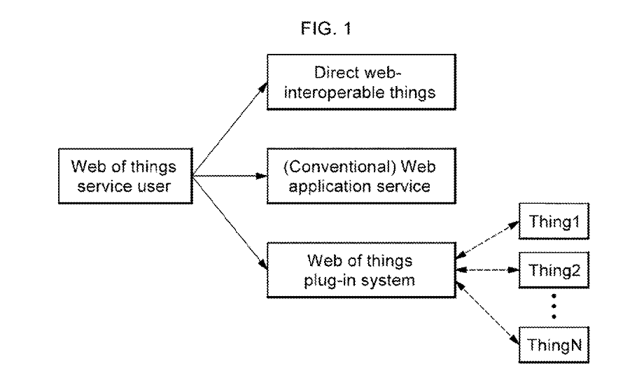

FIG. 1 is an exemplary view illustrating web of things service environment configuration in which embodiments of the present invention are applied.

In case of web-interoperable things (e.g., network attached storage) which can directly interface with web, a web of things service user may access information about the things, or control the things through the web like using conventional web application services. Here, information about things (hereinafter, referred also to as thing information) may include any data produced or collected by each thing as well as information about a thing's operation functions. For example, an air-conditioner or a heater as a part of a automatic temperature control system may measure room temperature around itself periodically and provide various control operations (e.g., room temperature may be lowered by controlling an air-conditioner's settings on air flow amount, air flow strength, fan direction, or dehumidification in case of an air-conditioner; room temperature may be increased by controlling a heater's settings on heating power, air flow amount, or heating period in case of a heater). Information about things related to an air-conditioner or a heater may be summarized as in Table 1.

TABLE 1

| | Detailed Information | |
|---|---|---|
| Thing | about things | Remarks |
| Air-conditioner | Manufacturer | ETRI |
| | Manufactured | Mar. 1, 2014 |
| | Manager | Gil D. Hong |
| | Model No. | ET-A-2014 |
| | Serial No. | A2014030001 |
| | Search strings | Cooling, temperature, humidity, |
| | | home appliance |
| | Current temperature | 28.43-Celsius |
| | Current humidity | 67.30-Percent |
| | Operation function 1 | Start cooling |
| | Operation function 2 | Stop cooling |
| | Operation function 3 | Measure temperature |
| | Operation function 4 | Measure humidity |
| Heater | Manufacturer | ETRI |
| | Manufactured | Feb. 15, 2014 |
| | Manager | Han K. Kim |
| | Model No. | ET-H-2014 |
| | Serial No. | H2014021234 |
| | Search strings | Heating, temperature, |
| | | home appliance |
| | Current temperature | 32.43-Celsius |
| | Operation function 1 | Start heating |
| | Operation function 2 | Stop heating |

However, since things may have different communication ways as well as distinctive processing capabilities among each other, a system supporting web resourcerization on thing information is needed in order to consistently provide information of each thing to a user through the web. Thus, exemplary embodiments of the present invention present a web of things plug-in system (WoT Plug-in (WP) System) capable of web resourcerization on thing information.

A web of things plug-in system may provide information of a corresponding thing as a web source (hereinafter, referred to as web of things resource) to a user by being interacted with various things through a local communication network.

In exemplary embodiments of the present invention, the local communication network includes a personal area network (PAN) and a local network.

PAN may be formed by a communication method according to IEEE (Institute of Electrical and Electronics Engineers) 802.15.1, or communication methods according to ISA (International Society of Automation) 100.11a or ZigBee or Bluetooth or Z-Wave, etc. Local network may be formed with a power line communication (PLC), M-Bus (Meter-Bus) protocol or a wireless M-Bus protocol.

Each web of things resource may have the following characteristics.

First, each web of things resource may be classified by unique resource identifier (URI). Second, resource processing of the web of things resource such as create, read, update, delete and the like may be conducted by a conventional web technique (for example, when a HTTP communication protocol is used, POST, GET, PUT, DELETE instruction may be used).

In case of thing information for an air-conditioner, each thing information may be identified with a unique resource identifier to be provided as a web resource to a user or another thing. Here, a web of things plug-in system allows for web protocol access through IP address 192.168.0.101. As summarized in Table 2 below, thing information for an air-conditioner may be provided through the GET instruction for the URI of ‘http://192.168.0.101/wp/devices/ETA2014-A2014030001’. A list of temperature measurements may be provided through the GET instruction for URI of ‘http://192.168.0.101/wp/devices/ETA2014-A2014030001/temp’. Air-conditioner operation functions for ‘Start cooling’ may be controlled through the GET instruction for URI of ‘http://192.168.0.101/wp/devices/ETA2014-A2014030001/on’. Data of web of things resources to be provided to a user as well as to another thing may be in a form of XML (Extensible Markup Language), JSON (JavaScript Object Notation) and text, etc.

TABLE 2

| | Web of things resources to be provided through the |
|---|---|
| URI | GET instruction for URI |
| http://192.168.0.101/wp/devices/ | Manufacturer: ETRI |
| ETA2014-A2014030001 | Manufactured: Mar. 1, 2014 |
| | Manager: Gil D Hong |
| | Model No.: ET-A-2014 |
| | Serial No.: A2014030001 |
| | Search strings: Cooling, temperature, humidity, home |
| | appliance |
| | Current temperature: 28.43-Celsius = /temp |
| | Current humidity: 67.30-Percent = /humid |
| | Operation function 1: Start cooling = /on |
| | Operation function 2: Stop cooling = /off |
| | Operation function 3: Reading temperature = /getTemp |
| | Operation function 4: Measure humidity = /getHumid |
| http://192.168.0.101/wp/devices/ | 28.43-Celsius, 20140705-10:50:23. |
| ETA2014-A2014030001/temp | 28.20-Celsius, 20140705-10:40:18. |
| | 28.14-Celsius, 20140705-10:30:13. |
| http://192.168.0.101/wp/devices/ | Function operation-Start cooling. |
| ETA2014-A2014030001/on | |
| http://192.168.0.101/wp/devices/ | 27.65-Celsius, 20140705-11:17:94. |
| ETA2014-A2014030001/getTemp | |

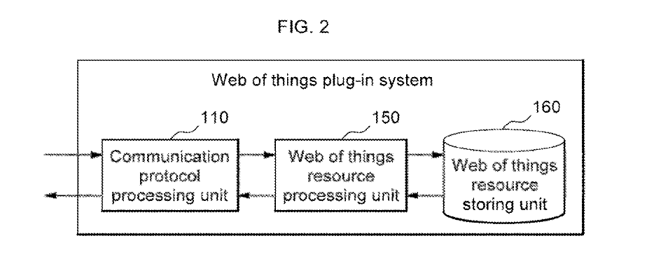

FIG. 2 is a block view illustrating a web of things plug-in system according to an embodiment of the present invention.

Referring to FIG. 2, a web of things plug-in system includes a communication protocol processing unit 110, a web of things resource processing unit 150 and a web of things resource storing unit 160.

The communication protocol processing unit 110 receives an access request to a specific web of things resource from a web of things service user and interprets the received access request. Here, the access request (or, it is called as a processing request) is to request for creating, reading, updating or deleting. In exemplary embodiments of the present invention, updating includes at least one of modification, addition and partial deletion of thing information for a corresponding web of things resource.

The communication protocol processing unit 110 delivers the interpreted access request to the web of things resource processing unit 150 and also delivers a response received from the web of things resource processing unit 150, which is corresponding to the access request, to a user.

The web of things resource processing unit 150 accesses to the web of things resources stored in the web of things resource storing unit 160 based on a kind of the access request. For example, when the request is a request for reading a web of things resource, the web of things resource processing unit 150 reads relevant information, or when the request is a request for updating a web of things resource, it updates relevant information. The web of things resource processing unit 150 may also deny the request by checking access privilege or access permission for a corresponding web of things resource.

The web of things resource storing unit 160 provides processing result of the access request to the web of things resource processing unit 150. For example, when the request is a request for reading a web of things resource, the web of things resource storing unit 160 provides a relevant web of things resource, or when the request is a request for updating a web of things resource, it updates a corresponding web of things resource and then provides the updated result.

Accordingly, the web of things resource processing unit 150 figures a response based on the resource processing result received from the web of things resource storing unit 160 and transmits the figured response to the communication protocol processing unit 110.

The web of things resource storing unit 160 may be implemented in at least one from of a file, a memory, a database, an external network storage and a removable storage.

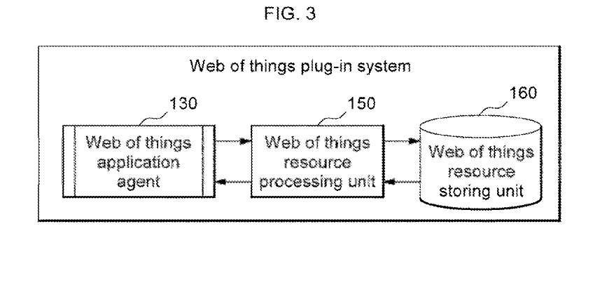

FIG. 3 is a block view illustrating a web of things plug-in system according to another embodiment of the present invention.

Referring to FIG. 3, a web of things plug-in system according to another embodiment of the present invention includes a web of things application agent 130, a web of things resource processing unit 150 and a web of things resource storing unit 160.

The web of things application agent 130 may generate a new web of things resource by using web of things resources stored in the web of things plug-in system, or update/delete an existing web of things resource. The web of things application agent 130 may generate a request for creating, updating or deleting a web of things resource representing an activation state of the web of things plug-in system itself and transmit the generated request to the web of things resource processing unit 150.

For example, when a specific web of things resource is created or updated with an attribute value which deviates from a predetermined range, the web of things application agent 130 may record system log or request for generating a new web of things resource to the web of things resource processing unit 150.

For example, when a temperature value detected by an air-conditioner is stored as a web of things resource(‘http://192.168.0.101/wp/devices/ETA2014-A2014030001/temp’), the web of things application agent for monitoring room temperature may read periodically the corresponding web of things resource. When a current temperature deviates from a certain range (18.0 Celsius to 30.0 Celsius), the web of things application agent may generate a new event data ('needs to control room temperature') as a web of things resource (‘http ://192.168.0.101/wp/applications/temp-monitoring/containers/event/contentInstances/event1’) and request for registering the generated web of thins resource to the web of things resource processing unit. Then, a user may check if the monitoring result is ‘normal’ or ‘needs to control room temperature’ by reading the corresponding web of things resource. This method may be used to provide the result integrated from one or more individual web of things resources as a new web of things resource. For example, the web of things application agent 130 may generate a web of things resource for outdoor wind chill temperature by using results from both a web of things resource for reading temperature and a web of things resource for reading wind speed, and provide the generated web of things resource to a user or a thing.

The web of things application agent 130 may generate a request for creating or updating information (such as operation start time, CPU utilization) about each component unit of the web of things plug-in system as web of things resources and transmit the request to the web of things resource processing unit 150.

The web of things resource processing unit 150 accesses to the web of things resources stored in the web of things resource storing unit 160 based on the request received from the web of things application agent 130.

Since the web of things resource storing unit 160 is the same with description with reference to FIG. 2, detail description thereabout will be omitted.

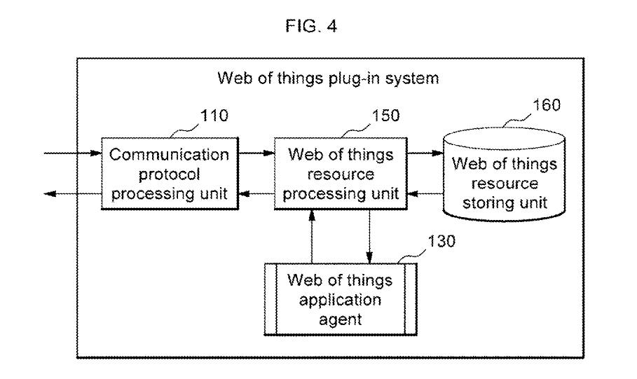

FIG. 4 is a block view illustrating a web of things plug-in system according to still another embodiment of the present invention.

Referring to FIG. 4, a web of things plug-in system according to still another embodiment of the present invention includes a communication protocol processing unit 110, a web of things application agent 130, a web of things resource processing unit 150 and a web of things resource storing unit 160.

The web of things plug-in system may provide a response to an access request for a web of things resource from outside such as a user or a thing through the web of things application agent 130.

For example, as described with reference to FIG. 2, the communication protocol processing unit 110 transmits an interpreted access request to the web of things resource processing unit 150 and also transmits a response for the access request received from the web of things resource processing unit 150 to a user. The web of things resource processing unit 150 directly accesses to the web of things resources stored in the web of things resource storing unit 160 based on a kind of the access request, or accesses to the web of things resources through the web of things application agent 130. For example, when a request for reading a web of things resource for the monitoring result of current room temperature is received from a user, the web of things resource processing unit 150 lets the web of things application agent 130 calculate the monitoring result of room temperature and generate a response message to be sent to the user based on the calculation result received from the web of things application agent 130, instead of searching the monitoring result of room temperature directly from web of things resource storing unit 160.

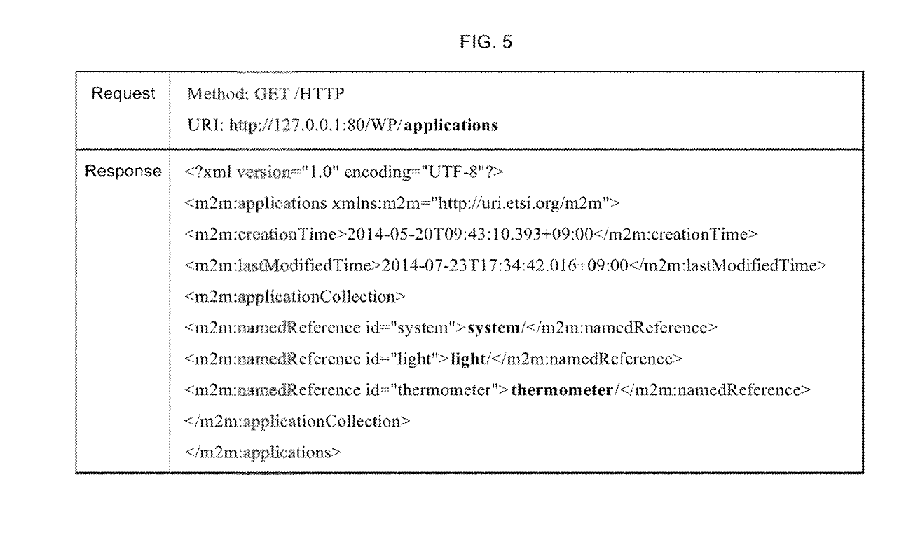

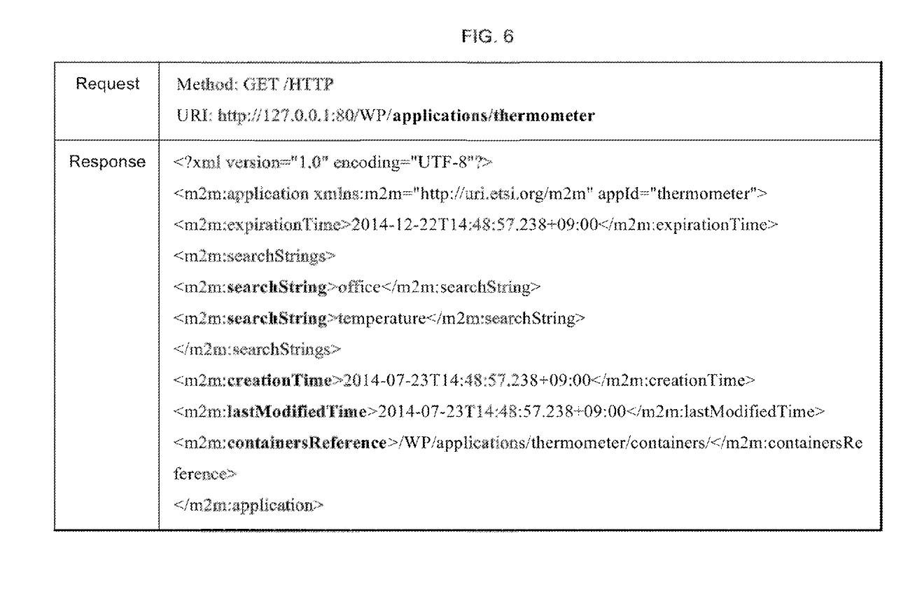

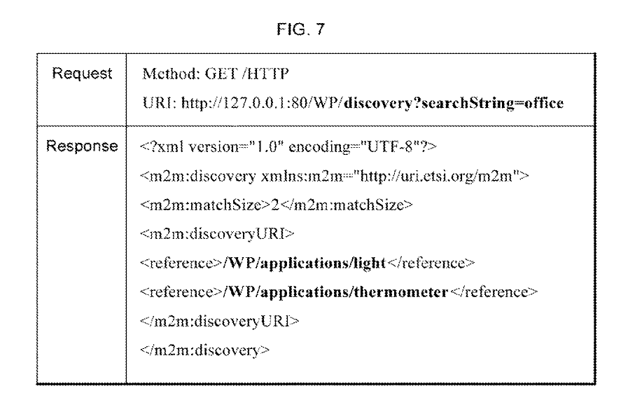

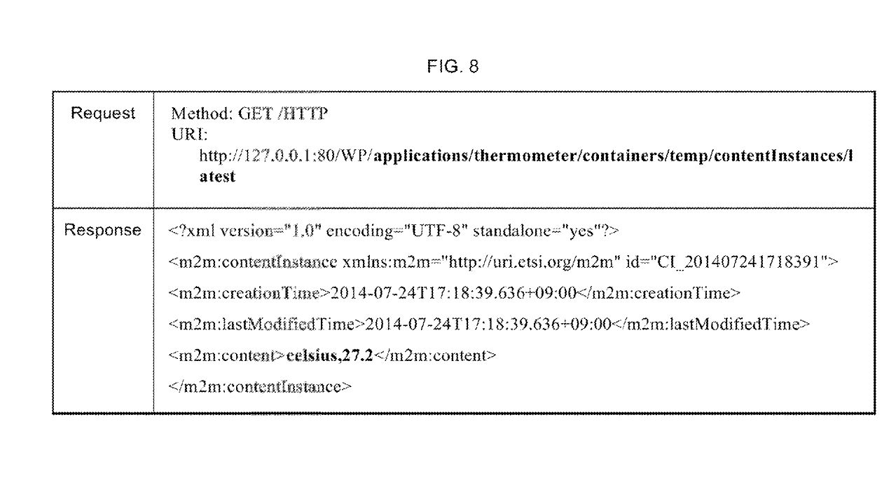

FIG. 5, FIG. 6, FIG. 7 and FIG. 8 are exemplary views illustrating processes for accessing a specific web of things resource accommodated by a web of things plug-in system, according to embodiments of the present invention.

In embodiments described with reference to FIG. 5, FIG. 6, FIG. 7 and FIG. 8, it is assumed that a request for reading a specific web of things resource is made by a service user, but the request may be also made by a specific thing or a web of things application agent.

In embodiments described with reference to FIG. 5, FIG. 6, FIG. 7 and FIG. 8, it is assumed that the web of things plug-in system provides ‘http://127.0.0.1:80/WP’ as an address for HTTP communication and a list of things connected to the web of things plug-in system through a resource URI of ‘http://127.0.0.1:80/WP/applications’.

Referring to FIG. 5, a service user may request a list of things which are connected to the web of things plug-in system by using client software. Here, it is assumed that the client software is a web browser using HTTP. The read request may be thus made by using “GET” instruction.

The web of things plug-in system provides a response to the read request to a user. FIG. 5 illustrates an example including three web of things resources of “system”, “light” and “thermometer” in the response.

FIG. 6 illustrates an example for reading a resource of “thermometer” among 3 web of things resources by a user. The read request may be made by using “GET” instruction.

The web of things plug-in system provides a response to the read request to a user. FIG. 6 illustrates an example including information about web of things resources of creationTime, lastModifiedTime, searchString and containersReference of “thermometer” in the response.

FIG. 7 illustrates an example for reading web of things resource by using searchString of “office” by a user.

The web of things plug-in system provides a response to the read request to a user. FIG. 7 illustrates an example including a list of web of things resource (light, thermometer) corresponding to “office” in the response.

FIG. 8 illustrates an example for reading temperature collected by “thermometer”.

The web of things plug-in system provides a response to the read request to a user. FIG. 8 illustrates an example including current temperature (Celsius, 27.2) collected by “thermometer” in the response.

As described with reference to FIG. 5, FIG. 6, FIG. 7 and FIG. 8, the web of things plug-in system processes information collected from a thing as a web of things resource and provides the result to a user.

In embodiments described with reference to FIG. 5, FIG. 6, FIG. 7 and FIG. 8, it is described for a read request for a specific web of things resource but any access request such as a create request, a update request and a delete request may be also made similarly.

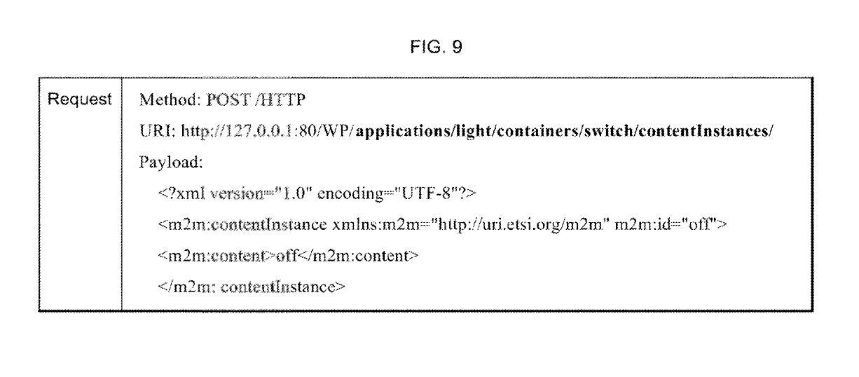

FIG. 9 is an exemplary view illustrating a process for controlling things' movement with a web of things plug-in system according to an embodiment of the present invention.

A user may control unique operational functions of a specific thing through an access request for web of things resources. For example, a user may turn on or turn off a light switch through a request for POST, GET or PUT for a specific web of things resource related to the light switch.

FIG. 9 illustrates a POST request for a web of things resource related to ‘light off’ at a location (‘http://127.0.0.1:80/WP/applications/light/containers/switch/contentInstance’) of the web of things resource corresponding to a ‘switch’ operational function of the ‘light’ thing. The web of things resource processing unit stores the web of things resource in the web of things resource storing unit and transmits an ‘off’ control instruction to the ‘light’ thing through the communication protocol processing unit.

Or, in an embodiment described with reference to Table 2, when a ‘GET’ request of a web of things resource (‘http://192.168.0.101/wp/devices/ETA2014-A2014030001/on’) related to a cooling function of an air-conditioner is received, the web of things resource processing unit may transmit a control instruction of ‘start cooling operation’ to the air-conditioner through the communication protocol processing unit without reading the web of things resource storing unit.

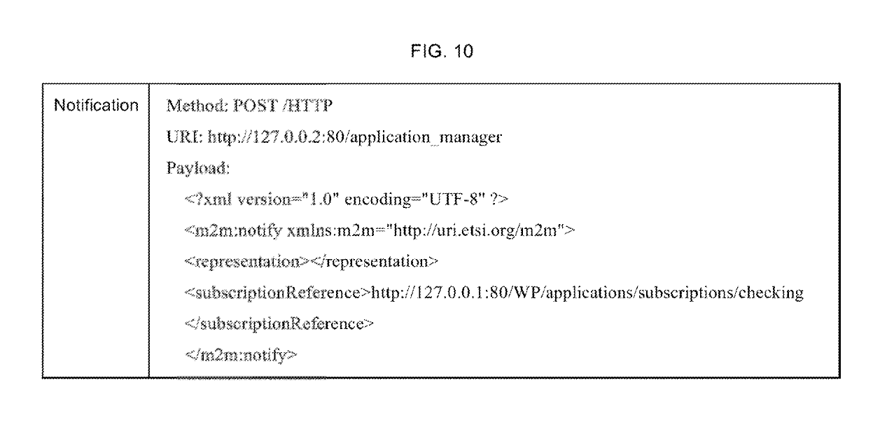

FIG. 10 is an exemplary view illustrating a notification process when a specific circumstance occurs in a web of things plug-in system according to an embodiment of the present invention.

When a predetermined specific incident occurs (e.g., a specific time is come, a specific request is received, or any change in a specific web of things resource is caused), the web of things plug-in system may transmit a notification to a user or a thing. For example, a user may set up subscription to be informed with a new temperature measured by a ‘thermometer’ whenever the new temperature is collected in order to avoid inconvenience which the user should request for reading temperature for the web of things resource in constant intervals to know the temperature collected by the ‘thermometer’ as shown in FIG. 8. The web of things resource processing unit 150 transmits a notification message to the communication protocol processing unit 110 which further transmits it to the user (or the thing) which is specified for subscription, when a specific web of things resource is created, updated or deleted and subscription for the specific web of things resource is satisfied.

FIG. 10 illustrates an example for transmitting a notification to a specific URI (http://127.0.0.2:80/application_manager) when a list of the things connected to the web of things plug-in system is changed.

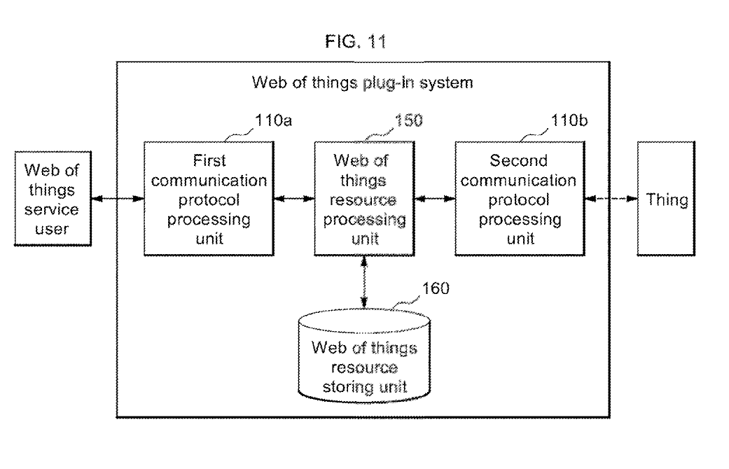

FIG. 11 is a block view illustrating a web of things plug-in system according to still another embodiment of the present invention.

Referring to FIG. 11, a web of things plug-in system according to another embodiment of the present invention includes a first communication protocol processing unit 110a, a second communication protocol processing unit 110b, a web of things resource processing unit 150 and a web of things resource storing unit 160.

The first communication protocol processing unit 110a may communicate with a web of things service user (terminal). For example, the first communication protocol processing unit 110a may perform communication with a user by using a web-based communication protocol.

The second communication protocol processing unit 110b may communicate with a thing. For example, the second communication protocol processing unit 110b may perform communication with a thing by using a local communication network protocol such as a PAN (personal area network) or LAN (local area network) protocol.

Functions of the other components are the same with description with reference to FIG. 2, detail description thereabout will be omitted.

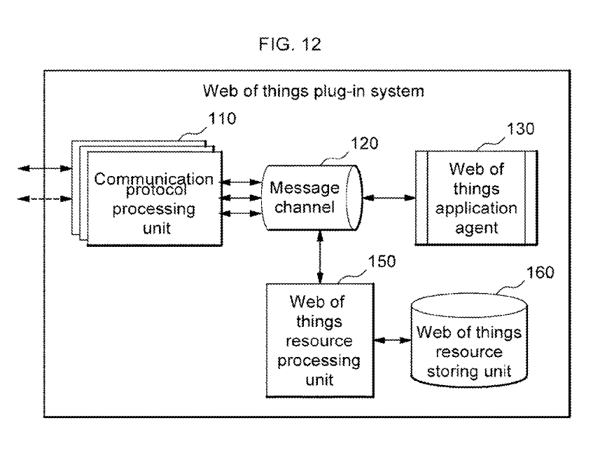

The web of things plug-in system has to provide functions of creating a new web of things resource or reading/updating/deleting an existing web of things resource to not only a user but also a thing. Furthermore, the web of things plug-in system has to consistently and accurately manage web of things resources for web of things resource processing requests(or access requests) from a plurality of users or a plurality of things. During processing a web of things resource according to a specific user or thing, the web of things plug-in system needs to prevent from mixing with another update request (or another delete request) for the web of things resource. This will be explained with reference to FIG. 12.

FIG. 12 is a block view illustrating a web of things plug-in system according to still another embodiment of the present invention.

Referring to FIG. 12, a web of things plug-in system according to still another embodiment of the present invention includes a communication protocol processing unit 110, a message channel 120, a web of things application agent 130, a web of things resource processing unit 150 and a web of things resource storing unit 160.

The web of things resource processing unit 150 may receive a web of things resource processing request from the communication protocol processing unit 110 and the web of things application agent 130 through the message channel 120. When more than one web of things resource processing request is received, the web of things resource processing unit 150 may process the requests sequentially based on a predetermined order.

For example, the web of things resource processing unit 150 may process the requests in the order of time when a resource processing request messaged is received.

Or, the web of things resource processing unit 150 may prioritize the requests from the web of things application agent 130, compared to those from the communication protocol processing unit 110.

Or, when the communication protocol processing unit 110 includes more than one local communication protocol processing unit to support more than one local communication protocol, the web of things resource processing unit 150 may process the requests in order based on a priority order of each local communication protocol processing unit. For example, the web of things resource processing unit 150 may prioritize the request through a local communication protocol processing unit supporting Bluetooth, compared to that through a local communication protocol processing unit supporting ZigBee.

Or, the web of things resource processing unit 150 may determine a processing order based on the type of resource processing requests (e.g., Creation, Read, Update, Deletion, Control and Notification). For example, the web of things resource processing unit 150 may prioritize a “creation” request compared to a “deletion” request.

Or, the web of things resource processing unit 150 may determine a processing order based on attributes of web of things resources (e.g., search strings, web of things resource name, URI length, storage location and the like).

As described above, conflicts may be prevented during the resource processing by performing resource processing based on a predetermined priority order.

Since the message channel 120 roles as buffer such as a temporally storage for more than one web of things resource processing request, the communication protocol processing unit 110 or the web of things application agent 130 is not needed to be in a blocking state (a standby state) till a response to a request is received after the request is transmitted to the web of things resource processing unit 150 so that it may perform another operation. The message channel 120 may be implemented in the form of a file, a shared memory, a pipe, a message queue, a message bus or a socket.

Basic operations for each component are the same with description with reference to FIG. 4, detail description thereabout will be omitted, except requests and responses among the communication protocol processing unit 110, the web of things application agent 130 and web of things resource processing unit 150 through the message channel 120.

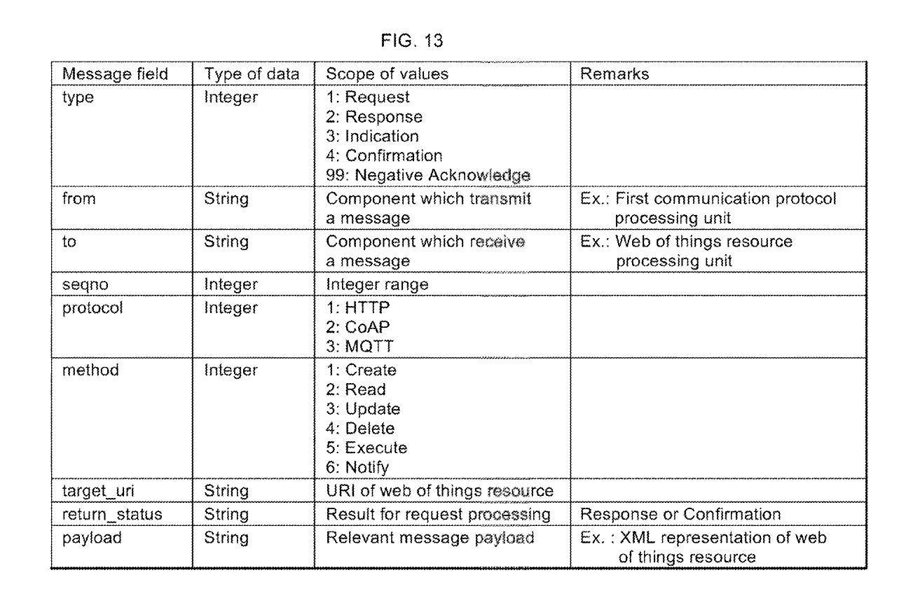

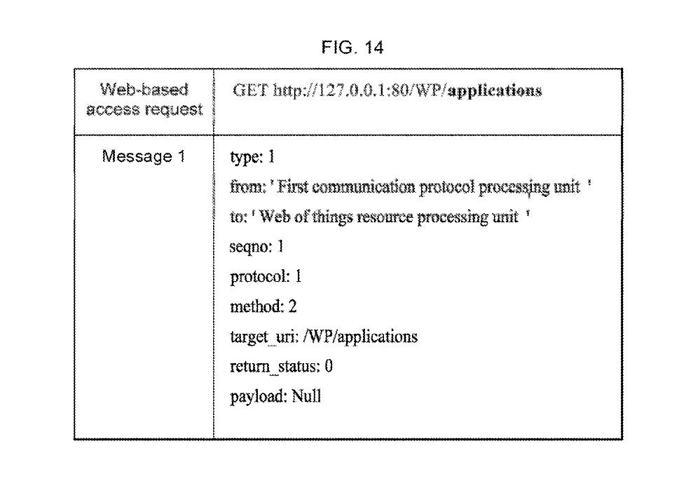

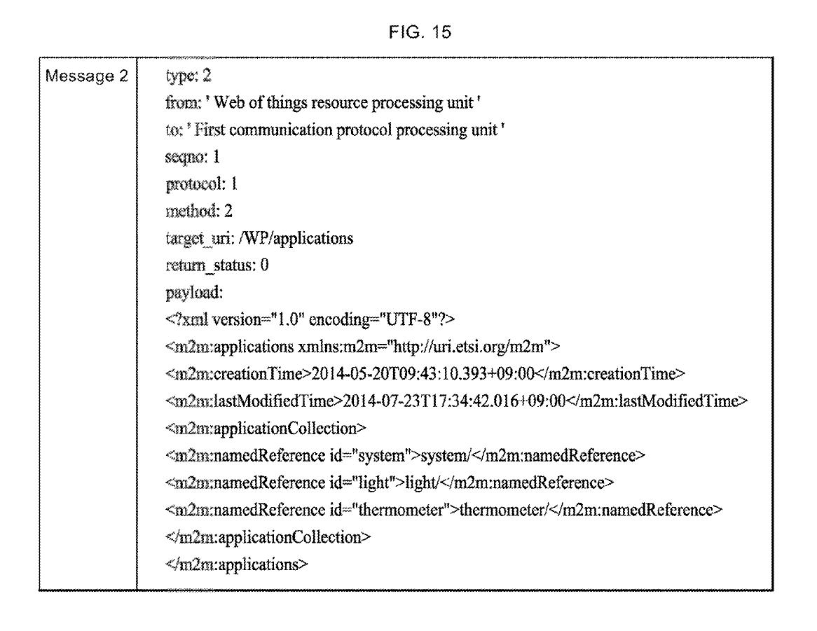

FIG. 13, FIG. 14 and FIG. 15 are exemplary views illustrating messages which are transmitted through a message channel according to an embodiment of the present invention.

Referring to FIG. 13, a data value of each message field may be represented by binary or general string (e.g., ascii text) or represented or transmitted/received after conversion according to various encoding methods (e.g., base64 encoding) and predetermined encryption processes.

The communication protocol processing unit 110 may provide an identification symbol (e.g., sequence number; seqno) to each request message when web of things resource processing requests from a user or a thing are transmitted to web of things resource processing unit 150 by using the message channel 120. Since each response message processed through the web of things resource processing unit 150 can be easily found by assigning an identification symbol to each request message transmitted through the message channel 120, more than one web of things resource processing request may be managed in order. For example, a HTTP communication protocol processing unit, which receives a HTTP read instruction for a specific web of things resource from a user, may receive a web of things resource processing request from a user 1 and then receive a web of things resource processing request from a user 2, which is a different user from the user 1, even before transmitting a corresponding response to the user 1. That is, each communication protocol processing unit may perform ID assignment for each web of things resource request, ID matching between the request message and the response message, retrieving memory used to receive the request after responding for the request to a user, and failure log writing for timeout when a response message is not provided for a certain time or longer, after receiving one or more processing requests till a response message for each processing request from the web of things resource processing unit is provided.

FIG. 14 illustrates an example of the message which the first communication protocol processing unit (e.g., web-based communication protocol processing unit) generates to transmit to web of things resource processing unit.

FIG. 15 illustrates an example of the message which the web of things resource processing unit generates to transmit to the first communication protocol processing unit (e.g., web-based communication protocol processing unit) as the message shown in FIG. 14 as the response.

Referring to FIG. 14 and FIG. 15, the sequence number “1” is assigned to each message.

Activation state for each component unit included in the web of things plug-in system should be managed. For example, when the web of things plug-in system operates initially or re-operates, activation of the web of things resource processing unit should be performed before the communication protocol processing unit receives a resource processing request from a user or a thing. This is because even though the communication protocol processing unit receives user's requests, the requests have to be stacked unnecessarily till the web of things resource processing unit operates normally and an activation state of the web of things resource processing unit have to be checked repeatedly which causes system load.

Therefore, it is needed to activate operation of the communication protocol processing unit after fully activating operation of the web of things resource processing unit and so does the web of things application agent since web of things resource access requests from the web of things application agent can be normally processed after operation of the web of things resource processing unit is activated.

As another example, even though operation of the web of things resource processing unit is ready, the web of things resource processing unit may be controlled not to be activated till operation of at least one communication protocol processing unit is ready. This is because when any request between a user and a thing cannot be made, it is not necessary to operate the web of things resource processing unit alone.

Exemplary embodiments which manage activation state as described above will be explained with reference to FIG. 16 to FIG. 18.

FIG. 16 is a block view illustrating a web of things plug-in system according to still another embodiment of the present invention.

Referring to FIG. 16, a web of things plug-in system according to still another embodiment of the present invention includes a communication protocol processing unit 110, a message channel 120, a web of things application agent 130, an activation management unit 140, a web of things resource processing unit 150 and a web of things resource storing unit 160.

The activation management unit 140 may determine activation state (e.g., active state, inactive state and unknown state) of the communication protocol processing unit 110 and the web of things resource processing unit 150 to control activation state of each component of the web of things plug-in system.

Operations of the other components are the same with description with reference to FIG. 12, detail description thereabout will be omitted.

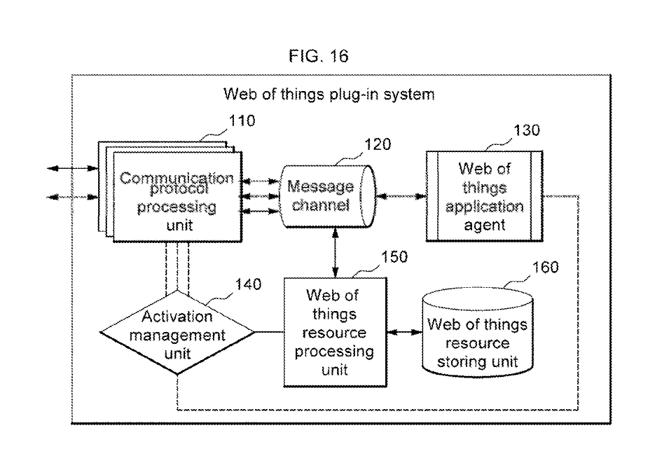

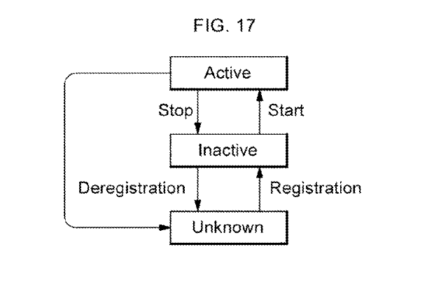

FIG. 17 is an exemplary view illustrating changes in activation states of component units included in a web of things plug-in system according to an embodiment of the present invention.

For example, when the web of things resource processing unit 150 becomes ready to operate, the activation management unit 140 records activation state of the web of things resource processing unit 150 from the unknown state to the inactive state.

The activation management unit 140 may generate a start signal to change the inactive state of the web of things resource processing unit 150 to the active state. The activation management unit 140 may also generate a stop signal to change the active state of the web of things resource processing unit 150 to the inactive state.

The activation management unit 140 may also generate a start signal to change the inactive state of the communication protocol processing unit 110 to the active state only when the web of things resource processing unit 150 is in the active state.

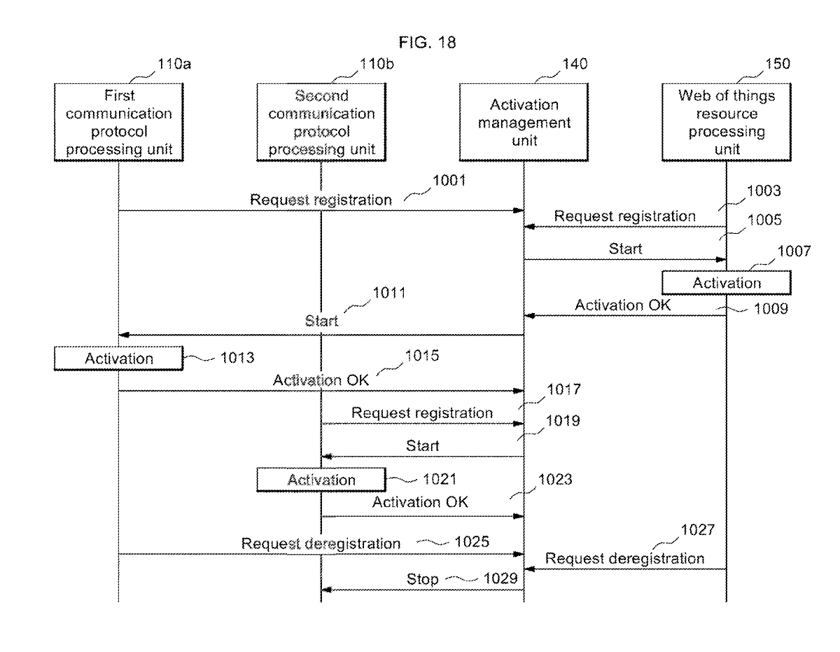

FIG. 18 is an exemplary view illustrating a process for controlling activation states of component units included in a web of things plug-in system according to an embodiment of the present invention by an activation management unit.

FIG. 18 illustrates an example in which the communication protocol processing unit includes a first communication protocol processing unit 110a and a second communication protocol processing unit 110b.

In Step 1001, the first communication protocol processing unit 110a notifies its inactive state (ready for operation) to the activation management unit 140. Here, the activation management unit 140 does not transmit an activation signal immediately to the first communication protocol processing unit 110a.

In Step 1003, when it is determined that operation of the web of things resource processing unit 150 is ready, in Step 1005, the activation management unit 140 transmits an activation signal to the web of things resource processing unit 150 and in Step 1007, activation of the web of things resource processing unit 150 is made.

In Step 1009, when activation of the web of things resource processing unit 150 is determined, in Step 1101, the activation management unit 140 transmits an activation signal to the first communication protocol processing unit 110a. In Step 1013, activation of the first communication protocol processing unit 110a can be made.

When in Step 1015, activation of the first communication protocol processing unit 110a is determined and in Step 1017, activation state of the second communication protocol processing unit 110b is determined, in Step 1019, the activation management unit 140 transmits an activation signal to the second communication protocol processing unit 110b. In Step 1021, activation of the second communication protocol processing unit 110b can be made.

When in Step 1023, activation of the second communication protocol processing unit 110b is determined and in Step 1025, activation state of the first communication protocol processing unit 110a is determined as end, the activation management unit 140 records the first communication protocol processing unit 110a is in the unknown state.

When in Step 1027, it is determined that the web of things resource processing unit 150 is ended, in Step 1029, the activation management unit 140 transmits a stop signal to the second communication protocol processing unit 110b which is in the active state. The second communication protocol processing unit 110b is then changed to the inactive state (ready to operate).

The exemplary embodiment of the present invention can be implemented by various methods. For example, the exemplary embodiment of the present invention can be implemented by using hardware, software or its combination. When they are implemented by software, they may be implemented as software executing in more than one processor using various operating systems or platforms. In addition, the software may be created by using any language among various appropriate programming languages or be compiled in machine language codes or intermediate codes executable in a framework or virtual machine.

In addition, when the exemplary embodiment of the present invention is executed in more than one processors, the exemplary embodiment of the present invention may be implemented by processor readable media such as a memory, a floppy disk, a hard disk, a compact disk (CD), an optical disk or a magnetic tape, or the like in which more than one programs are recorded to conduct the implementation of various exemplary embodiments of the present invention.

What is claimed is:

1. A web of things plug-in system comprising:
a web of things resource storing unit configured to store web of things resources which represent at least one of a thing itself and any data produced by the thing; and
a web of things resource processing unit configured to perform resource processing on the web of things resources stored in the web of things resource storing unit.

2. The web of things plug-in system of claim 1, further comprising a communication protocol processing unit configured to transmit a web of things resource processing request to the web of things resource processing unit and to output web of things resource processing result received from the web of things resource processing unit corresponding to the web of things resource processing request.

3. The web of things plug-in system of claim 2, wherein the communication protocol processing unit comprises:
a web-based communication protocol processing unit configured to receive the web of things resource processing request from a user terminal and output the web of things resource processing result to the user terminal; and
a local communication protocol processing unit configured to receive the web of things resource processing request from the thing, and to output the web of things resource processing result to the thing.

4. The web of things plug-in system of claim 2, further comprising a message channel configured to be located between the communication protocol processing unit and the web of things resource processing unit and to transmit at least one of the web of things resource processing request and the web of things resource processing result.

5. The web of things plug-in system of claim 2, further comprising an activation management unit configured to control activation states of component units included in the web of things plug-in system based on activation state of the web of things resource processing unit.

6. The web of things plug-in system of claim 5, wherein the activation management unit activates the communication protocol processing unit when the web of things resource processing unit converts from an inactive state to an active state.

7. The web of things plug-in system of claim 6, wherein the activation management unit deactivates the communication protocol processing unit when the web of things resource processing unit converts from an active state to an inactive state.

8. The web of things plug-in system of claim 1, further comprising a web of things application agent configured to generate a new web of things resource based on the web of things resource stored in the web of things resource storing unit, update the web of things resource stored in the web of things resource storing unit, or generate information of its own web of things plug-in system as web of things resources and store the result in the web of things resource storing unit.

9. The web of things plug-in system of claim 1, wherein the resource processing is related to any one of creating, storing, searching, reading, updating and deleting.

10. The web of things plug-in system of claim 1, wherein the web of things resource processing unit transmits an instruction to control the thing to the thing, when any resource processing of creating, reading, and updating is made.

11. The web of things plug-in system of claim 1, wherein the web of things resource processing unit transmits, when a predetermined circumstance occurs, notification relating to circumstance to the user or to the thing which is related to the circumstance.

12. The web of things plug-in system of claim 1, wherein the web of things resources are web resources to which at least one of information about things and operation functions of the things is converted.
